(19) United States
(12) Patent Application Publication
(10) Pub. No.: US 2012/0171322 A1
(43) Pub. Date: Jul. 5, 2012

(54) FEED ATTRACTANT AND SUPPLEMENT

(76) Inventor: Millard Chuck Eddington, Harrison, AR (US)

(21) Appl. No.: 12/981,938

(22) Filed: Dec. 30, 2010

(51) Int. Cl. A23K 1/18; A23K 1/175

(52) U.S. Cl. 426/1

(57) ABSTRACT

An inventive feed attractant and supplement having stabilized rice bran, corn and soybean meal. Salt, vitamins, minerals and flavoring are further included to the mixture. More specifically, the inventive feed attractant and supplement has between 35% and 45% rice bran, between 25% and 35% soybean meal and 20% and 25% cracked corn, with salt, vitamins, minerals and flavoring making up the remainder.

### REFERENCE TO PENDING APPLICATIONS

This application does not claim the benefit of any pending patent application.

### REFERENCE TO MICROFICHE APPENDIX

This application is not referenced in any microfiche appendix.

### BACKGROUND OF THE INVENTION

This invention relates to a deer feed, and more specifically to a deer feed and supplement having a combination of rice bran, corn and soybean meal.

Prior art deer feeds and attractants, such as corn and salt, are not optimal for deer's health. Needs exist for deer feeds and attractants that are beneficial to deer and herds.

### SUMMARY OF THE INVENTION

The inventive deer feed described herein satisfies the needs set out above.

An aspect of the present invention a deer feed attractant and supplement comprising mostly of stabilized rice bran, corn and soybean meal. Salt, vitamins, minerals and flavoring are added to the mixture during the mixing process. There is no rice bran, corn and soybean meal being sold in the deer attractant/feed/supplement market.

The product contains approximately 40% rice bran, 30% soybean meal and 25% cracked corn, with minerals, vitamins, salt and flavoring making up the rest of the product. The resulting attractant and supplement promotes deer health and growth, and the growth of antlers as well. The attractant promotes stronger does and bucks, which promotes healthier, better offspring. The deer feed may be spread out in the wild for deer to eat to cause herd distribution throughout resource areas and away from crops and gardens.

One aspect of the rice bran has the following analysis: protein 12.5%, fat 12.0% and fiber 12.0%. One aspect of the cracked corn has the following analysis: protein 8.0%, fat 2.7% and fiber 3.8%. One aspect of the soybean meal has the following analysis: protein 46.5%, fat 0.5% and fiber 3.5%.

Upon reading the included description, various alternative embodiments will become obvious to those skilled in the art. These embodiments are to be considered within the scope and spirit of the subject invention, which is only limited by the claims which follow and their equivalents.

### DESCRIPTION OF THE PREFERRED EMBODIMENTS

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims. The invention is capable of other embodiments and of being practiced or carried out in a variety of ways. It is to be understood that the phraseology and terminology employed herein are for the purpose of description and not of limitation.

An embodiment of the inventive feed attractant and supplement is shown below. This embodiment comprises stabilized rice bran, corn and soybean meal. Salt, vitamins, minerals and flavoring are added to the mixture during the mixing process. More specifically, this embodiment comprises between 35% and 45% rice bran, between 25% and 35% soybean meal and 20% and 25% cracked corn, with salt, vitamins, minerals and flavoring making up the remainder.

One example of this embodiment includes 41% rice bran, 29% soybean meal and 23% cracked corn, with 4% salt, 2% vitamins and minerals and 1% flavoring.

An embodiment of the rice bran includes between 10% and 15% protein, 10% and 15% fat and 10% and 15% fiber. One embodiment of the cracked corn includes between 5% and 10% protein, between 2% and 3% fat and between 3% and 4% and fiber. One embodiment of the soybean meal includes between 40% and 50% protein, between 0.1% and 1% fat and between 2% and 4% fiber.

An example of this embodiment includes rice bran having 12.5% protein, 12.0% fat and 12.0% fiber; cracked corn having 8.0% protein, 2.7% fat and 3.8% fiber; and soybean meal having 46.5% protein, 0.5% fat and 3.5% fiber.

While embodiments of the present invention have been illustrated and described, such disclosures should not be regarded as any limitation of the scope of our invention. The true scope of our invention is defined in the appended claims. Therefore, it is intended that the appended claims shall be construed to include both the preferred embodiment and all such variations and modifications as fall within the spirit and scope of the invention.

We claim:

1. A method of attracting and feeding deer comprising:
depositing on the ground a deer attractant and supplement,
wherein the deer attractant and supplement comprises:
between 35% and 45% rice bran, between 25% and 35% soybean meal and 20% and 25% cracked corn, with salt, vitamins, minerals and flavoring making up the remainder.

2. The method of claim 1 wherein the deer attractant is further defined as having between 3% and 5% salt, between 1% and 2% vitamins and minerals and between 0.5% and 1% flavoring.

3. The method of claim 1 wherein said rice bran comprising:
between 10% and 15% protein;
between 10% and 15% fat; and
between 10% and 15% fiber.

4. The method of claim 1 wherein said cracked corn comprises:
between 5% and 10% protein;
between 2% and 3% fat; and
between 3% and 4% and fiber.

5. The method of claim 1 wherein said soybean meal comprises:
between 40% and 50% protein;
between 0.1% and 1% fat; and
between 2% and 4% fiber.

6. A deer attractant and supplement comprising:
between 35% and 45% rice bran;
between 25% and 35% soybean meal;
between 20% and 25% cracked corn, and salt, vitamins, minerals and flavoring making up the remainder.

7. The deer attractant and supplement of claim 1 wherein the deer attractant is further defined as having between 3% and 5% salt, between 1% and 2% vitamins and minerals and between 0.5% and 1% flavoring.

8. The deer attractant and supplement of claim 1 wherein said rice bran comprising:
between 10% and 15% protein;
between 10% and 15% fat; and
between 10% and 15% fiber.

9. The deer attractant and supplement of claim 1 wherein said cracked corn comprises:
between 5% and 10% protein;
between 2% and 3% fat; and
between 3% and 4% and fiber.

10. The deer attractant and supplement of claim 1 wherein said soybean meal comprises:
between 40% and 50% protein;
between 0.1% and 1% fat; and
between 2% and 4% fiber.
